(19) United States
(12) Patent Application Publication
(10) Pub. No.: US 2006/0168151 A1
(43) Pub. Date: Jul. 27, 2006

(54) Method, system and computer program for retrieving information with reduced age in a periodic process

(76) Inventors: Umberto Caselli, Roma (IT); Attilio Mattiocco, Roma (IT)

Correspondence Address: IBM CORPORATION;INTELLECTUAL PROPERTY LAW, 11400 BURNET ROAD, AUSTIN, TX, 78758, US

(21) Appl. No.: 11/394,298

(22) Filed: Mar. 30, 2006

(30) Foreign Application Priority Data
Jan. 4, 2005 (EP) 05102578.1

(51) Int. Cl. G06F 15/16

(52) U.S. Cl. 709/219

(57) ABSTRACT

A solution (600) for retrieving information (for example, monitoring data such as heartbeat signals) is proposed. The information is collected (603-612) periodically on a central server (110) from remote sources (105); multiple clients (120) then download (615-630) the information from the server with a time pattern that is tied to the period of the collection. In the proposed solution, each client at every iteration estimates (633) the time at which the different information items will be received on the server from the corresponding sources at the next iteration (for example, considering a delay for their collection equal to the one of the last iteration). The client then determines (636-651) the time of the next request to be submitted to the server so as to minimize the corresponding total age of the information items.

### TECHNICAL FIELD

The present invention relates to the data processing field. More specifically, the present invention relates to the retrieval of information that is collected periodically.

### BACKGROUND ART

Data processing systems are routinely used to retrieve information, for example, in interactive applications where the information is displayed on a monitor in real-time. Particularly, in a system with distributed architecture multiple remote source computers provide the required information. In this case, the information is typically collected on a central server computer (from the different source computers); the information can then be downloaded from the server computer by several client computers.

In many practical applications, the information is collected by the server computer periodically, and then stored into a cache memory. In this case, the client computers are synchronized with the server computer, so as to retrieve the information from the server computer with the same period as it is collected from the source computers. This ensures that the information is refreshed on the client computers according to the rate of its updating on the server computer.

A typical example is a monitoring application (such as the “IBM Tivoli Monitoring, or ITM”), wherein monitoring data indicative of the performance of the source computers is measured on each one of them and then collected on the server computer; in this context, the monitoring data can simply consist of a heartbeat signal, which indicates that the corresponding source computer is alive. A typical use case involves the continuous display of the monitoring data on a console of the client computer. The periodic refresh of the monitoring data allows an operator to have an up-to-date view of the health and performance of the system. Typically, this information is used to detect any critical condition of the source computers (and possibly to take corresponding corrective actions); for example, when an expected heartbeat signal is not received in a significant time frame, it is possible to assume a crash of the corresponding source computer.

A problem of the above-described system is that of ensuring an acceptable degree of currency of the information that is delivered to the client computers. Indeed, the client computers receive the information as it was when collected from the source computers (and stored into the cache memory of the server computer) ahead of its actual retrieval; therefore, the age of the information can span from a very low value (ideally zero when the information is retrieved just after its collection) to a very high value (up to the period of the process when the information is retrieved just before its collection).

Moreover, any drift of an internal clock of each client computer with respect to the one of the source computer results in a skew of the periods that control the retrieval of the information and its collection, respectively. This phenomenon adversely affects the currency of the information that is delivered to the client computer (which age typically increases with the time difference between the two periods).

### SUMMARY OF THE INVENTION

The present invention proposes a solution, which is based on the idea of dynamically updating a phase difference between the collection of the information on the source computer and its retrieval by the client computers.

Particularly, an aspect of the present invention proposes a method for retrieving information in a data processing system. The method includes the following steps. At first, a plurality of information items are collected on a server entity (such as a computer) from corresponding source entities (or computers) with a predetermined period; each information item is obtained at a measured completion time (for example, indicating when it was received on the server entity). For each collection, the plurality of information items is retrieved from the server entity on one or more client entities (or computers); the operation is performed at a corresponding retrieve time. For each information item, the completion time of the next collection is estimated according to one or more corresponding measured completion times. The retrieve time of the next retrieval is now set according to the retrieve time of the last retrieval, to said period, and to the estimated completion times, in order to optimize the age of the information items at the next retrieval.

In this way, at every cycle the phase difference between the start time of the collection of the information items on the server computer and its retrieval by the client computers is updated.

The proposed solution strongly improves the currency of the information that is retrieved by the client computers.

Moreover, this approach self-adapts to any drift of the internal clocks of the client computers with respect to the one of the source computer (since their operation is automatically synchronized at every cycle).

In a preferred embodiment of the invention, the next completion time is set to the last measured completion time.

This choice provides an acceptable degree of accuracy with a very simple implementation.

In a specific embodiment of the invention, the next retrieve time is determined by optimizing an age function, which defines a total age of the information items.

A preferred age function for achieving this purpose (defined taking the last retrieve time as the time base) is also proposed.

In an implementation of the invention, the optimization is carried out by evaluating the age function for the next retrieve time equal to the next collection times (or a subset thereof); the value that minimizes such evaluation is then selected.

This solution takes advantage of the observation that the minimum of the age function can only occur at the collection times; as a result, it is possible to avoid calculating the age function for any possible value of the next retrieve time.

In a preferred embodiment of the invention the age function is instead evaluated for the next retrieve time equal to a set of eligible values (which are distributed around the last retrieve time plus the period of the process).

The proposed choice strongly reduces the computational complexity of the algorithm; in any case, it does not substantially impair the accuracy of the results that are obtained. Moreover, the proposed technique has slow dynamics and then filters out any transient phenomena.

Advantageously, three eligible values are used.

This choice has been found to be a good compromise between the opposed requirements of accuracy and simplicity.

Another aspect of the present invention provides a corresponding service.

A further aspect of the present invention provides a computer program for performing the above-described method.

A still further aspect of the invention provides a program product embodying this computer program.

A different aspect of the invention provides a corresponding data processing system.

The characterizing features of the present invention are set forth in the appended claims. The invention itself, however, as well as further features and advantages thereof will be best understood by reference to the following detailed description, given purely by way of a nonrestrictive indication, to be read in conjunction with the accompanying drawings.

### BRIEF DESCRIPTION OF THE DRAWINGS

FIG. 1a is a schematic block diagram of a data processing system in which the solution according to an embodiment of the invention is applicable;

FIG. 1b shows the functional blocks of an exemplary computer of the system;

FIG. 2 depicts the main software components that can be used for practicing the solution according to an embodiment of the invention;

FIG. 3 is a qualitative time diagram illustrating an exemplary operation of the system;

FIGS. 4a-4c show a table and two corresponding time-curves detailing the operation of a simple illustrative system;

FIGS. 5a-5b are further qualitative time diagrams relating to the operation of an exemplary system;

FIGS. 6a-6b show a diagram describing the flow of activities relating to an implementation of the solution according to an embodiment of the invention; and

FIG. 7 depicts an exemplary scenario of application of the solution according to an embodiment of the invention.

### DETAILED DESCRIPTION OF THE PREFERRED EMBODIMENT(S)

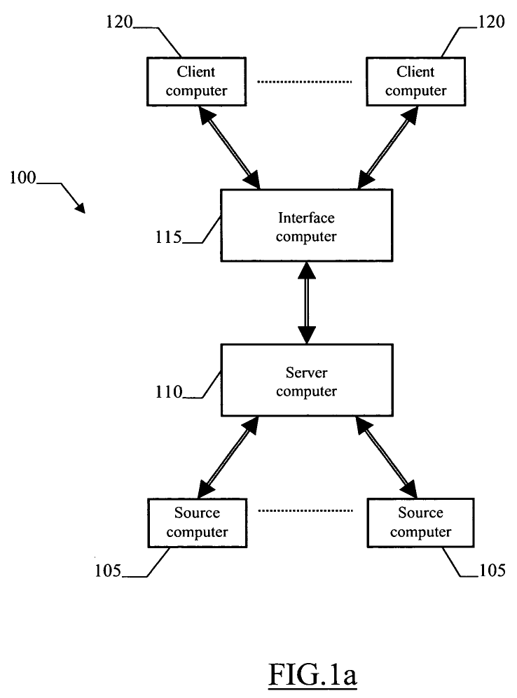

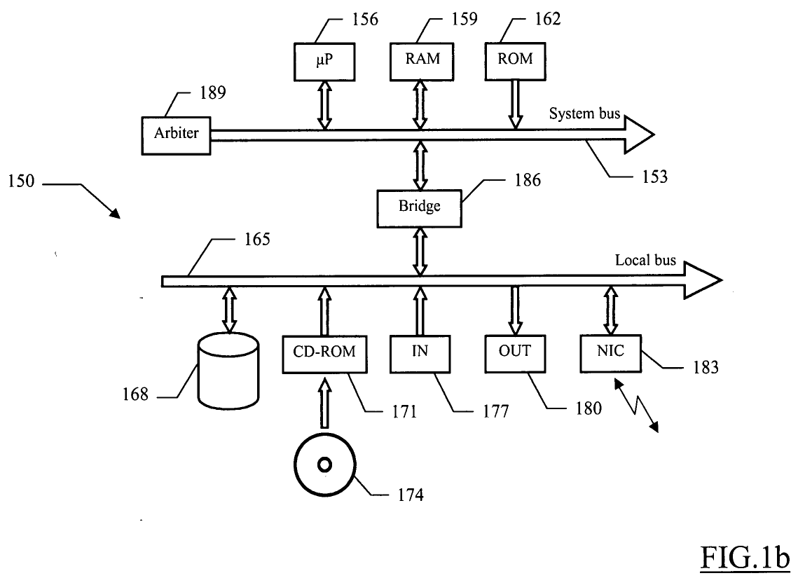

With reference in particular to FIG. 1a, a data processing system 100 with distributed architecture is illustrated. The system 100 includes multiple source computers 105 (for example, of the order of some hundreds), each one providing corresponding information items. A central server computer 110 periodically collects the information items from the different source computers 105. The server computer 110 communicates with an interface computer 115. The interface computer 115 delivers the collected information items to multiple client computers 120 on demand.

For example, the system 100 runs a monitoring application that is used to trace operation of the source computers 105 (representing the entities that are managed in the monitoring application); in this case, the information items consist of monitoring data of the source computers 105 (such as heartbeat signals indicating that the source computers 105 are alive). Typically, the information provided to the client computers 120 is displayed on a console of an operator; this allows the operator to monitor the health and performance of the system 100.

As shown in FIG. 1b, a generic computer of the system (source computer, server computer, interface computer, or client computer) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to a network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

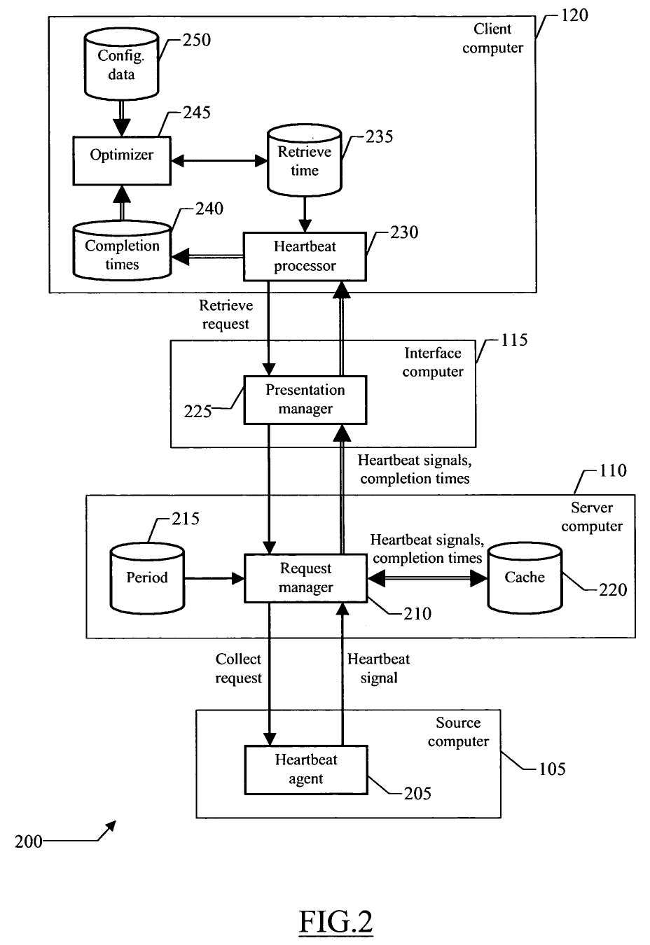

Moving now to FIG. 2, the main software components that define the monitoring application (running on the different computers of the system) are denoted as a whole with the reference 200. The information (programs and data) is typically stored on the hard disks and loaded (at least partially) into the corresponding working memories when the monitoring application is running. The programs are initially installed onto the hard disks from CD-ROMs.

Considering in particular a generic source computer 105, a heartbeat agent 205 returns a heartbeat signal to a request manager 210 (running on the server computer 110) in response to a collect request; for example, the heartbeat signal consists of an identifier of the source computer 105 (indicating its availability). The request manager 210 continually submits the collect requests to all the source computers according to a predefined period, which is stored in a register 215. Each heartbeat signal, together with a timestamp indicating when the heartbeat signal was received on the server computer 110 (hereinafter denoted as completion time), is saved by the request manager 210 into a cache memory 220 (replacing its preceding value); therefore, the cache memory 220 stores the last available versions of all the heartbeat signals with their completion times (which are periodically refreshed as described above).

The request manager 210 communicates with a presentation manager 225 running on the interface computer 115. The presentation manager 225 exposes a web interface, which is accessed by each client computer 120 through a corresponding heartbeat processor 230. The presentation manager 225 bridges between the heartbeat processor 230 and the request-manager 210. Particularly, the presentation manager 225 allows the client computer 120 to submit retrieve requests to the server computer 110 continually; in response thereto, the request manager 210 extracts the available heartbeat signals with their completion times from the cache memory 220, and returns this information to the client computer 120. In other words, the client computer 120 and the server computer 110 operate according to a pull paradigm (wherein the desired information is retrieved on-demand).

The heartbeat processor 230 submits the retrieve request when a corresponding retrieve time (stored in a register 235) expires. As it will be apparent in the following, the retrieve requests have a time pattern that is tied to the period of the collect requests (submitted by the server computer 110 to the source computers for collecting the heartbeat signals); however, the time pattern of the retrieve requests changes dynamically (at every cycle) in an attempt to minimize the age of the heartbeat signals that are received from the source computer 110.

For this purpose, the heartbeat processor 230 saves the completion times of the last heartbeat signals (which have just been received) into a log 240. An optimizer 245 extracts the retrieve time of the last retrieve request from the register 235 and the completion times of the corresponding heartbeat signals from the log 240; the optimizer 245 also accesses a table 250 storing configuration data, and particularly the total number of source computers and the period of the collect requests (submitted by the server computer 110 ). As described in detail in the following, the optimizer 245 determines the retrieve time of the next retrieve request, which is stored into the register 235 (replacing its preceding value).

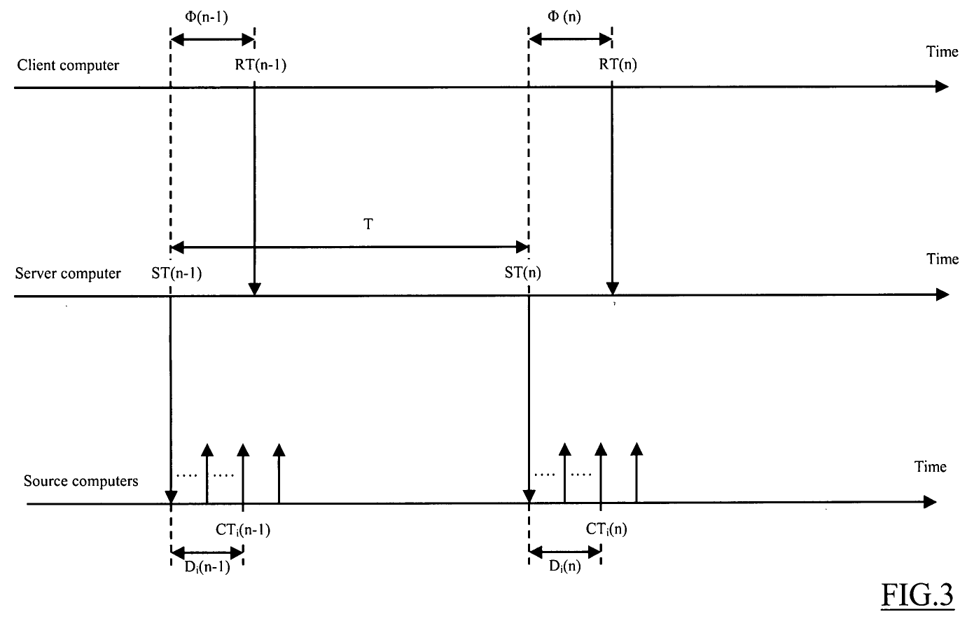

As shown in FIG. 3, at a generic n-th cycle iterating the above-described operations the server computer starts collecting the heartbeat signals from the different source computers (by submitting the corresponding collect requests) at a start time ST(n)=n·T; each pair of consecutive start times ST(n−1) and ST(n) are spaced apart by the period T (for example, of the order of some minutes). Each source computer returns its heartbeat signal after a collect delay Dᵢ(n), with i=1 . . . P (being P the number of source computers). The collect delay Dᵢ(n) (for example, of the order of some seconds) generally changes among the different source computers and from each cycle to the other because of several factors (such as the processing power of the source computer, its workload, the bandwidth of a connection with the server computer, and so on). The completion time of each heartbeat signal (indicating when it was actually received on the server computer) is then CTᵢ(n)=ST(n)+Dᵢ(n).

The retrieve time of a generic client computer (triggering the submission of the retrieve request to the server computer at every cycle) is denoted with RT(n); each pair of corresponding retrieve time RT(n) and start time ST(n) have a phase difference φ(n)=RT(n)−ST(n). The client computer receives the last version of each heartbeat signal that is available on the server computer; therefore, an age Aᵢ(n) of the i-th heartbeat signal is given by the difference between the retrieve time RT(n) and the last completion time of the heartbeat signal, i.e., CTᵢ(n) if RT(n)>=CTᵢ(n) or CTᵢ(n−1) if RT(n)<CTᵢ(n). Therefore, a total age of the heartbeat signals

$$A ( n ) = {\sum }_{i} {A}_{i} ( n )$$

strongly depends on the phase difference φ(n).

For example, let us consider a simple system with four source computers only (N=4) and a period T=10s; for the sake of simplicity, it is also assumed that the collect delays for each source computer are constant; particularly, the first source computer has a collect delay D₁=D₁(n−1)=D₁(n)=1s, the second source computer has a collect delay D₂=D₂(n−1)=D₂(n)=3s, the third source computer has a collect delay D₃=D₃(n−1)=D₃(n)=5s, and the fourth source computer has a collect delay D₄=D₄(n−1)=D₄(n)=6s.

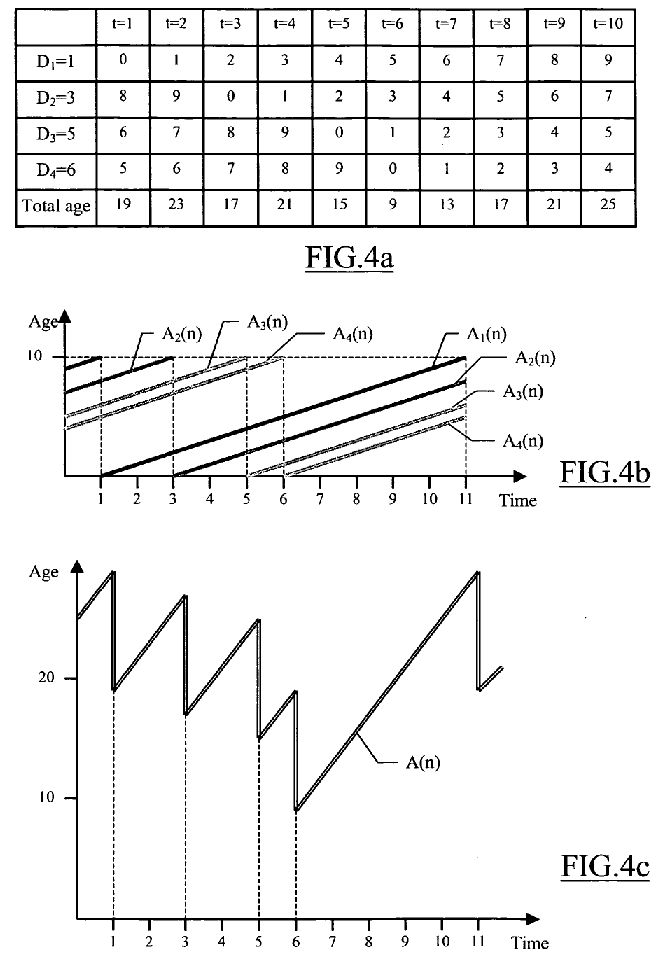

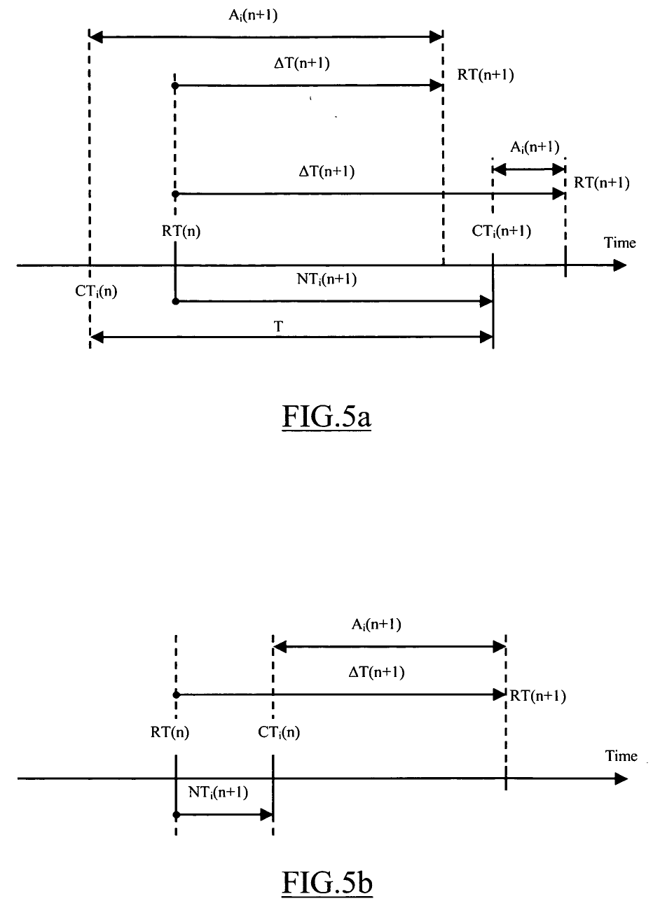

The variation of the age Aᵢ(n) of each heartbeat signal and of the corresponding total age A(n) at the n-th cycle (as a function of when the client computer submits the corresponding retrieve request to the server computer) is illustrated in FIGS. 4a-4c. More specifically, FIG. 4a tabulates the ages Aᵢ(n) of the four heartbeat signals and the total age A(n) for the phase difference φ(n) (between the retrieve request and the collect request) ranging from 1s to 10s. The time-curves illustrating the same ages Aᵢ(n) are shown in the FIG. 4b, while the time-curve illustrating the same total age A(n) is shown in FIG. 4c.

More in detail, if the phase difference φ(n)=1 the heartbeat signal from the first source computer has just been received and A₁(n)=0; the age A₁(n) then increases with the phase difference φ(n) (returning to zero when the heartbeat signal is received again after the period T=10s). On the other hand, considering again the instant when the phase difference φ(n)=1, the heartbeat signal from the second source computer has not been received yet in response to the corresponding collect request; therefore, the client computer will receive the heartbeat signal that was cached during the preceding cycle, and then with an age A₂(n)=T−D₂(n−1)+φ(n)=10−3+1=8. The age A₂(n) further increases with the phase difference φ(n) until the heartbeat signal is received after the collect delay D₂(n)=3 and then A₂(n)=0; the age A₂(n) now starts increasing again to reiterate the same behavior. Similar considerations apply to the third and fourth source computers, with A₃(n)=0 when φ(n)=D₃=5 and A₄(n)=0 when φ(n)=D₄=6.

As can be seen in the figures, the total age A(n) exhibits a discontinuity point at every completion time CTᵢ(n), when a new heartbeat signal is received from the respective source computer. This is due to the sharp reduction of the corresponding age Aᵢ(n) of the heartbeat signal (which passes from the period T to zero).

At every n-th cycle, the optimizer of the client computer determines the retrieve time RT(n+1) of the next retrieve request that should minimize the corresponding total age A(n+1). Preferably, this analysis is based on the assumption that the collect delays Dᵢ(n+1) at the next cycle will be the same as the ones Dᵢ(n) at the last cycle.

In order to formalize a function defining the (estimated) total age A(n+1), the last retrieve time RT(n) is taken as the time base; the next retrieve time RT(n+1) is then RT(n+1)=RT(n)+ΔT(n+1), where ΔT(n+1) is the time difference to be determined. Likewise, we can define the completion time for each heartbeat signal that will be available at the next cycle in terms normalized with respect to the retrieve time RT(n) as NTᵢ(n+1)=MOD_{T}[CTᵢ(n)=RT(n)]. As shown in FIG. 5a, if CTᵢ(n)<=RT(n) we have that:
NTᵢ(n+1)=T−[RTᵢ(n)−CT(n)]=T−RTᵢ(n)+CT(n);
conversely, as shown in FIG. 5b, if CTᵢ(n)>RT(n) we have that:
NTᵢ(n+1)=CTᵢ(n)−RT(n).

Therefore, in both the cases shown in the figures if ΔT(n+1)>=NTᵢ(n+1) the age of the corresponding heartbeat signal at the next cycle will be:
Aᵢ(n+1)=ΔT(n+1)−NTᵢ(n+1);
conversely, if ΔT(n+1)<NTᵢ(n+1) (being relevant for the first case only) the age of the same heartbeat signal will be:
Aᵢ(n+1)=ΔT(n+1)+T−NTᵢ(n+1).
It is then possible to express the total age A(n+1) as:

$$A ( n + ( 1 ) = {\sum }_{i} {A}_{i} ( n + 1 ) = {\sum }_{Δ T ( n + 1 ) >= {NT}_{i} ( n + 1 )} [ Δ T ( n + 1 ) - {NT}_{i} ( n + 1 ) ] + {\sum }_{Δ T ( n + 1 ) < {NT}_{i} ( n + 1 )} [ Δ T ( n + 1 ) + T - {NT}_{i} ( n + 1 ) ] = P \cdot Δ T ( n + 1 ) - {\sum }_{i} {NT}_{i} ( n + 1 ) + {\sum }_{Δ T ( n + 1 ) < {NT}_{i} ( n + 1 )} ( T ) = P \cdot Δ T ( n + 1 ) - {\sum }_{i} {NT}_{i} ( n + 1 ) + {\sum }_{i} \{ 1 - u [ Δ T ( n + 1 ) - {NT}_{i} ( n + 1 ) ] \} \cdot T$$

where u( ) is the step function defined for a generic variable x as:
u(x)=0 for x<=0
u(x)=1 for x>0

Therefore (for a given number of source computers P), if the normalized completion times NTᵢ(n+1) are estimated as described above, i.e., by setting them according to the last completion times CTᵢ(n), the total age function A(n+1) only depends on the time difference ΔT(n+1). The desired time difference ΔT(n+1) can thus be obtained by minimizing the total age function A(n+1). For this purpose, it is not necessary to calculate the total age function A(n+1) for every possible value of the time difference ΔT(n+1). Indeed, as observed above, the minimum of the total age function A(n+1) can only occur at one of its discontinuity points, which are now defined by the normalized completion times NTᵢ(n+1). Therefore, it is possible to evaluate the total age function A(n+1) by setting the time difference ΔT(n+1) equal to every normalized completion time NTᵢ(n+1), and then select the time difference ΔT(n+1) that provides the lowest value of the total age function A(n+1). However, this operation can be relatively time consuming, especially when the system includes a high number of source computers P (because of the need to calculate two summations over that number P for each source computer).

A possible solution involves the search of a local minimum of the total age A(n+1) function (instead of its global minimum described above); for this purpose, the total age function A(n+1) is evaluated for a subset of the normalized completion times NTᵢ(n+1) only; preferably, the subset consists of the normalized completion times NTᵢ(n+1) that fall in a range centered around the period T. For example, the subset consists of all the normalized completion times NTᵢ(n+1) included from 0.7 T to 1.3 T, preferably from 0.8 T to 1.2 T, and still more preferably from 0.9 T to 1.1 T. This choice reduces the computational complexity of the algorithm, without substantially impairing its accuracy. However, in some practical situations the number of normalized completion times NTᵢ(n+1) to be taken into account can remain relatively high (especially when their distribution is very narrow); in any case, the identification of the normalized completion times NTᵢ(n+1) falling within the desired range requires their complete listing.

In a preferred embodiment of the invention, the optimization of the total age function A(n+1) is instead based on the observation that its time pattern shows a fast step-like decrease after each start time (as a result of the collection of the heartbeat signals from the different source computers) followed by a slow increase up to their next collection. Therefore, the minimum value of the total age function A(n+1) in any case falls close to the period T. This observation has led to the choice of evaluating the total age function A(n+1) for predefined eligible values of the time difference ΔT(n+1). Particularly, the eligible values of the time difference ΔT(n+1) are selected around the period T. For example, it is possible to select the period T itself, and one or more other values preceding and following the period T by a predefined percentage thereof. Preferably, the eligible values of the time difference ΔT(n+1) are in an odd number (for example, 3-7) and are uniformly spaced in the same range as in the preceding implementation. A suggested choice for the eligible values of the time difference ΔT(n+1) consists of 0.9 T, T and 1.1 T. The proposed solution dramatically reduces the computational complexity of the algorithm. Nevertheless, simulation tests have shown that the retrieve time converges towards its actual optimum in a relatively low number of cycles. Moreover, the proposed algorithm has a more conservative behavior provided by its slow dynamics, since at every cycle the retrieve time can be adjusted only by a predefined value (equal to ±0.1 T in the example at issue). This filters out any transient phenomena that might cause a sharp increase or decrease of the collect delays of the different source computers.

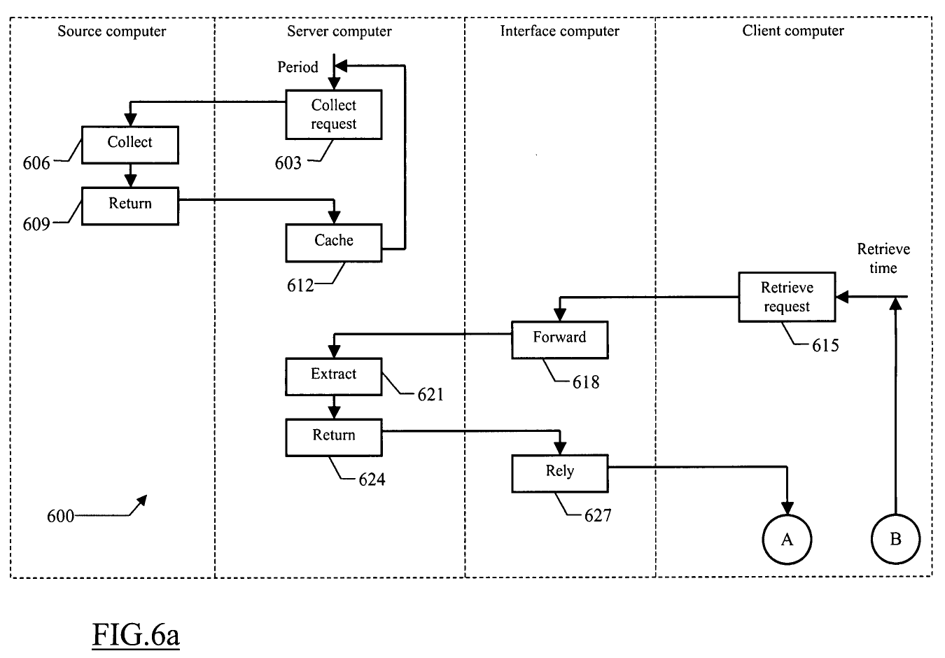

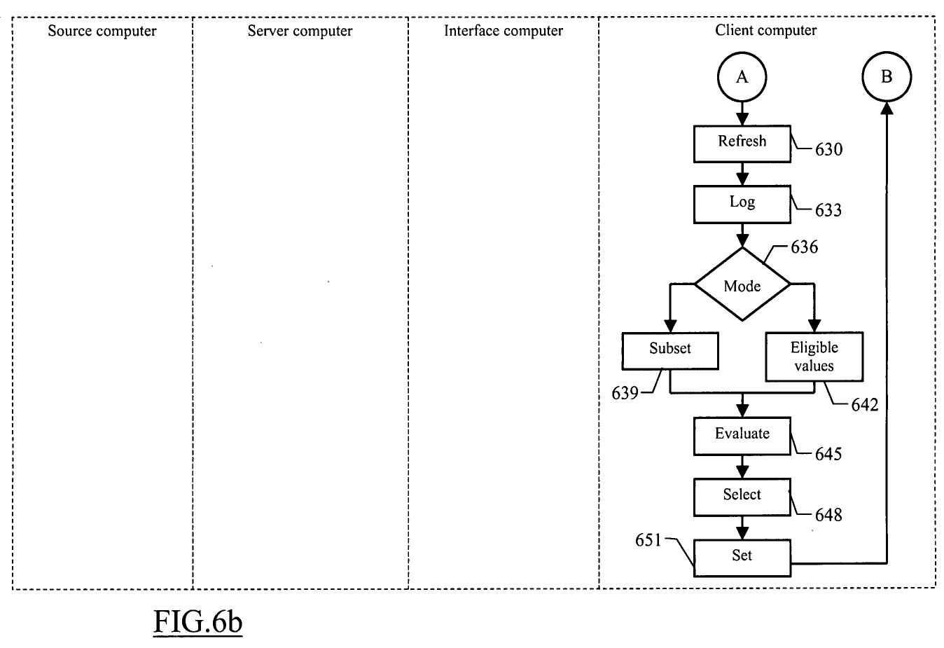

Considering now FIGS. 6a-6b, the logic flow of a process according to an embodiment of the invention is represented with a method 600. The method enters block 603 in the swimlane of the server computer whenever the period T expires; in response thereto, the server computer submits the collect request to all the source computers. Each source computer (independently) generates the corresponding heartbeat signal at block 606. The heartbeat signal is then returned to the server computer at block 609. Referring back to the swimlane of the server computer (block 612), each heartbeat signal with the corresponding timestamp is saved into the cache memory as soon as it is received. The flow of activity then returns to block 603 for repeating the same operations periodically.

At the same time, each client computer at block 615 submits the retrieve request when the corresponding retrieve time expires. The interface computer forwards the retrieve request to the server computer at block 618. In response thereto, the server computer at block 621 extracts the heartbeat signals (with the corresponding completion times) from the cache memory. The information so obtained is returned to the interface computer at block 624. The interface computer in turn relays the information to the client computer at block 627. As a result, the client computer at block 630 refreshes its console with the new version of the heartbeat signals. Continuing to block 633, the corresponding completion times are saved into the dedicated log.

The method then branches at block 636 according to the operating mode of the client computer. Particularly, the values of the time difference to be used for searching the (local) minimum of the total age function are set to the normalized completion times at block 639 or to the eligible values at block 642. In both cases, the total age function is then evaluated for each one of those values at block 645. The time difference that provides the lowest value of the total age function is selected at block 648. Proceeding to block 651, the next retrieve time is set accordingly. The flow of activity then returns to block 615 for repeating the above-described operations continually (when the new retrieve time expires), until the client computer decides to stop the process.

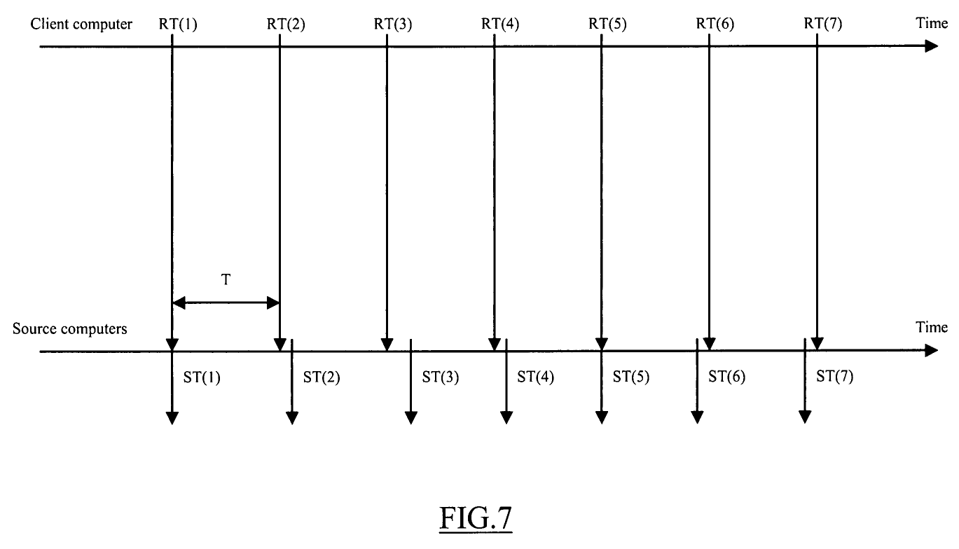

An exemplary scenario relating to the application of the above-described algorithm is illustrated in FIG. 7. In this case, the process starts with the client computer that is perfectly synchronized with the server computer at the first cycle, i.e., RT(1)=ST(1). According to the last completion times CTᵢ(1), the optimizer determines that the preferred time difference ΔT(2) defining the next retrieve time RT(2) is 0.9 T. Therefore, the client computer submits the next retrieve request to the server computer with a phase difference φ(2)=−0.1 T with respect to the corresponding start time ST(2). The time difference ΔT(3) is set again to 0.9 T, and then the phase difference becomes φ(3)=−0.2 T. The process continues with the time difference ΔT(4)=1.1 T leading to the phase difference φ(4)=−0.1 T, the time difference ΔT(5)=1.1 T leading to the phase difference (5)=0, the time difference ΔT(6)=1.1 T leading to the phase difference φ(6)=+0.1 T, the time difference ΔT(6)=T leaving the phase difference unchanged at φ(7)=+0.1 T, and so on. As can be seen, the time difference ΔT(n+1) can vary at every cycle for minimizing the total age A(n) of the heartbeat signals; however, it remains always tied to the (fixed) period T of the collect requests that are submitted by the server computer to the source computers.

### MODIFICATIONS

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the system has a different structure or includes equivalent components; moreover, the system can be based on any number of source computers and/or client computers (down to a single one), or the client computers can access the server computer directly (without any interface computer). Likewise, each computer can have another structure or it can be replaced with any data processing entity (such as a PDA, a mobile phone, and the like).

Even though in the preceding description reference has been made to a monitoring application, this is not to be intended in a limitative manner; indeed, the invention can be applied for retrieving any type of information that is collected from the source computers periodically (for example, news provided by press agencies, stock exchange lists provided by multiple sites, and the like).

In any case, it is not excluded the possibility of setting the completion times on each source computer directly (thereby disregarding the time required for its transmission to the server computer), or of determining the retrieve times for all the client computers on the server computer.

Similar considerations apply if an equivalent function is optimized (for example, maximizing a total currency of the heartbeat signals); likewise, it is possible to optimize any other function based on the ages of the heartbeat signals (for example, minimizing their average).

Alternatively, the range of the values that are used to evaluate the total age function can have another lower limit and/or upper limit (possibly not centered around the period). Likewise, the percentage of the period that is used to define the eligible values used for the same purpose can be different.

Moreover, it is possible to implement the same solution in a system that deploys a corresponding service. For example, the server computer (associated with a service provider) can operate according to the push paradigm (where the information is transmitted to the client computers by the server computer of its own motion at the expire of each retrieve time).

Similar considerations apply if the programs are structured in another way, or if additional modules or functions are provided; likewise, the memory structures can be of different types, or they can be replaced with equivalent entities (not necessarily consisting of physical storage media). Moreover, the proposed solution can be implement with an equivalent method (for example, with similar or additional steps).

In any case, it is possible to distribute the programs in any other computer readable medium (such as floppy-disks).

Moreover, it will be apparent to those skilled in the art that the additional features providing further advantages are not essential for carrying out the invention, and may be omitted or replaced with different features.

For example, an implementation wherein the next completion times are estimated with more sophisticated techniques is contemplated. Particularly, it is possible to take into account two or more measured completion times for the estimation, to calculate their running average, or more generally to apply any desired statistical analysis.

Moreover, it should be readily apparent that the same results can also be achieved determining the next retrieve time with equivalent techniques.

Likewise, even though in the preceding description reference has been made to a specific total age function, this is not to be intended as a limitation (with the concepts of the present invention that can be applied to any other function based on equivalent variables).

Alternatively, the total age function can be optimized with different algorithms.

For example, it is possible to select the subset of normalized completion times to be taken into account according to a different criterion (even changing dynamically).

Similar considerations apply to the selection of the eligible values.

In any case, the use of a different number of eligible values (either odd or even) is feasible; moreover, they can be selected in another way (for example, according to a parameter changing dynamically, and even with a distribution that is not centered around the period).

In a different implementation of the invention, the programs are sent to the computers through the network, are broadcast, or more generally are provided in any other form directly loadable into the working memory of the computers.

At the end, the method according to the present invention lends itself to be carried out with a hardware structure (for example, integrated in chips of semiconductor material), or with a combination of software and hardware.

1. A method for retrieving information in a data processing system including the steps of:
collecting a plurality of information items on a server entity from corresponding source entities with a predetermined period, each information item being obtained at a measured completion time,
for each collection, retrieving the plurality of information items from the server entity on at least one client entity at a corresponding retrieve time,
for each information item, estimating the completion time of the next collection according to at least one corresponding measured completion time, and
setting the retrieve time of the next retrieval according to the retrieve time of the last retrieval, to said period, and to the estimated completion times for optimizing the age of the information items at the next retrieval.

2. The method according to claim 1, wherein the step of estimating the completion time of the next collection includes:
setting the completion time of the next collection to the last measured completion time.

3. The method according to claim 1, wherein the step of setting the retrieve time of the next retrieval includes:
optimizing an age function defining an indication of the total age of the plurality of information items as a function of an indication of the retrieve time of the last retrieval, of said period, and of the estimated completion times.

4. The method according to claim 3, wherein the age function consists of the product of the number of source entities by a time difference between the retrieve time of the next retrieval and the retrieve time of the last retrieval, minus the summation for each source entity of the corresponding completion time made relative to the retrieve time of the last retrieval, plus the summation for each source entity of the product of the period by a factor, the factor consisting of 1 minus the step function of the time difference minus the corresponding relative completion time.

5. The method according to claim 3 on, wherein the step of optimizing includes:
evaluating the age function for the time difference equal to at least a subset of the relative completion times, and
selecting the time difference minimizing the evaluation of the age function.

6. The method according to claim 3, wherein the step of optimizing includes:
evaluating the age function for the time difference equal to a plurality of eligible values being distributed around the period, and
selecting the time difference minimizing the evaluation of the age function.

7. The method according to claim 6, wherein the eligible values consist of the period minus a percentage thereof, of the period, and of the period plus said percentage.

8. A method for deploying a service for retrieving information in a data processing system including the steps of claim 1.

9. A computer program including program code means directly loadable into a working memory of a data processing system
for retrieving information in a data processing system comprising of:
instructions for collecting a plurality of information items on a server entity from corresponding source entities with a predetermined period, each information item being obtained at a measured completion time,
for each collection, instructions for retrieving the plurality of information items from the server entity on at least one client entity at a corresponding retrieve time, characterized by the steps of
for each information item, instructions for estimating the completion time of the next collection according to at least one corresponding measured completion time, and
instructions for setting the retrieve time of the next retrieval according to the retrieve time of the last retrieval, to said period, and to the estimated completion times for optimizing the age of the information items at the next retrieval.

10. (canceled)

11. A data processing system
for retrieving information in a data processing system, comprising;
means for collecting a plurality of information items on a server entity from corresponding source entities with a predetermined period, each information item being obtained at a measured completion time,
means for retrieving the plurality of information items for each collection from the server entity on at least one client entity at a corresponding retrieve time,
means for estimating the completion time of the next collection for each information item according to at least one corresponding measured completion time, and
means for setting the retrieve time of the next retrieval according to the retrieve time of the last retrieval, to said period, and to the estimated completion times for optimizing the age of the information items at the next retrieval.
